(19) United States
(12) Patent Application Publication
(10) Pub. No.: US 2026/0084756 A1
(43) Pub. Date: Mar. 26, 2026

(54) VEHICLE LOWER BODY STRUCTURE

(71) Applicant: MAZDA MOTOR CORPORATION, Hiroshima (JP)

(72) Inventors: Harumitsu KUBOTA, Aki-gun (JP); Morihide YAMADA, Aki-gun (JP); Takuya SAEKI, Aki-gun (JP)

(73) Assignee: MAZDA MOTOR CORPORATION, Hiroshima (JP)

(21) Appl. No.: 19/302,409

(22) Filed: Aug. 18, 2025

(30) Foreign Application Priority Data
Sep. 20, 2024 (JP) 2024-163858

(51) Int. Cl. B62D 25/02; B62D 25/20

(52) U.S. Cl. CPC B62D 25/025; B62D 25/2027

(57) ABSTRACT

A vehicle lower body structure ensures desired side collision performance when a floor panel is joined to a portion higher than a center position of a side sill. A floor cross member coupling a pair of left and right side sills includes an upper member fixed to a floor panel upper surface protruding upward in the vehicle, and having a cross member upper surface facing upward in the vehicle; and a lower member fixed to a floor panel lower surface and protruding downward in the vehicle. The side sill and the floor cross member are joined to align positions of a side sill upper surface and the cross member upper surface in a vehicle up-down direction, and form a closed cross section with the front floor panel disposed between the upper member and the lower member, the upper member, and the lower member in a front-rear direction vertical cross section.

### TECHNICAL FIELD

The present disclosure relates to a vehicle lower body structure in which a floor panel is joined to portions of left and right side sills above center positions in a vehicle up-down direction.

### BACKGROUND

In general, a vehicle lower body structure today includes a pair of left and right side sills extending in a vehicle front-rear direction, a floor panel provided between the pair of left and right side sills, and a floor cross member fixed to an upper surface of the floor panel and coupling the pair of left and right side sills in the vehicle width direction.

As disclosed in JP2020-055473A, in regard to a collision load from a vehicle lateral side during a side collision (hereinafter referred to as a side collision load), such a vehicle lower body structure is configured to transmit the collision load to the opposite side in the vehicle width direction by the floor cross member coupling the pair of left and right side sills in the vehicle width direction. More specifically, the vehicle lower body structure transmits the side collision load acting on one of the pair of left and right side sills to the other side sill via the floor cross member extending in the vehicle width direction.

As described above, in the vehicle lower body structure, in order to efficiently transmit the side collision load from one of the side sills to the other side sill, it is necessary to align positions of upper surfaces, where ridgeline portions of the side sill and the floor cross member are formed, in a vehicle up-down direction and to increase cross-sectional strength of the floor cross member in a vertical cross section along the vehicle front-rear direction (hereinafter referred to as a front-rear direction vertical cross section).

However, as disclosed in JP2020-055473A, for example, in an electric vehicle, since a battery is disposed under a floor, the floor panel may be disposed higher in the vehicle than that in a vehicle without the battery. In such a case, the floor panel is joined to a portion of the side sill above a center position in the vehicle up-down direction.

As described above, when the floor panel is joined to the portion of the side sill above the center position in the vehicle up-down direction, the ridgeline portions can be made continuous by aligning the positions in the vehicle up-down direction of the upper surfaces, where the ridgeline portions having relatively high strength are formed, in the side sill and the floor cross member. However, the cross-sectional area of the floor cross member in the front-rear direction vertical cross section becomes small, and there is a possibility that the sufficient cross-sectional strength cannot be secured. Therefore, it cannot be said that the side collision load can be efficiently transmitted from the one side sill to the other side sill, and there is room for improvement.

### SUMMARY

In view of the above-described problem, the disclosure provides a vehicle lower body structure capable of securing desired side collision performance even when a floor panel is joined to a portion of a side sill above a center position in a vehicle up-down direction.

The disclosure is a vehicle lower body structure including a floor panel; a pair of left and right side sills that extends in a vehicle front-rear direction at opposing lateral ends in a vehicle width direction of the floor panel; and a floor cross member that extends in the vehicle width direction and couples the pair of left and right side sills, in which the side sills each have a side sill upper surface facing upward in the vehicle and each have a closed cross section in a vertical cross section along the vehicle width direction.

The floor cross member includes an upper member that is fixed to a floor panel upper surface of the floor panel, protrudes in a vehicle up direction, and has a cross member upper surface facing upward in the vehicle; and a lower member fixed to a floor panel lower surface of the floor panel and protruding downward in the vehicle, and the side sill and the floor cross member are joined to align positions of the side sill upper surface and the cross member upper surface in the vehicle up-down direction, and the upper member, the lower member, and the floor panel between the upper member and the lower member form a closed cross section in a vertical cross section along the vehicle front-rear direction.

The above-described floor cross member that extends in the vehicle width direction and couples the pair of left and right side sills may have both end portions directly connected and coupled to the side sills, or may be connected thereto via seat attachment brackets or gussets provided to both end portions.

That the side sill and the floor cross member described above are joined to align the positions of the side sill upper surface and the cross member upper surface in the vehicle up-down direction may be joining to align the upper surface of the side sill and the upper surface of the cross member in the vehicle width direction or may be joining to make the upper surface of the cross member partially overlap the upper surface of the side sill. Furthermore, in the case where the side sill upper surface is an inclined surface that is inclined in the vehicle up-down direction with respect to the vehicle width direction, the side sill and the floor cross member described above mean that, in the vehicle up-down direction, the cross member upper surface is disposed within a range from an upper end position to a lower end position of the inclined side sill upper surface.

According to the disclosure, it is possible to ensure desired side collision performance even when the floor panel is joined to a portion of the side sill located higher than a center position thereof in the vehicle up-down direction. More specifically, the vehicle lower body structure includes: the pair of left and right side sills extending in the vehicle front-rear direction at both lateral ends in the vehicle width direction of the floor panel; and the floor cross member extending in the vehicle width direction and coupling the pair of left and right side sills. The side sill has the side sill upper surface facing upward in the vehicle, and has the closed cross section in the vertical cross section along the vehicle width direction (hereinafter, referred to as a width direction vertical cross section).

In addition, the floor cross member has: the upper member fixed to the floor panel upper surface as the upper surface of the floor panel, protruding upward in the vehicle, and having the cross member upper surface facing upward in the vehicle; and the lower member fixed to the floor panel lower surface as the lower surface of the floor panel and protruding downward in the vehicle.

Then, the side sill and the floor cross member are joined in the manner to align positions of the side sill upper surface and the cross member upper surface in the vehicle up-down direction. The ridgeline portion, which extends in the vehicle front-rear direction and forms the side sill upper surface in the side sill, and the ridgeline portion, which extends in the vehicle width direction and forms the cross member upper surface in the floor cross member, have higher rigidity than the other portions in the respective members. Just as described, the ridgeline portions, the rigidity of which is high in the respective members, extend in directions substantially orthogonal to each other in the plan view but are located at substantially the same positions in the vehicle up-down direction. That is, the ridgeline portion of the floor cross member and the ridgeline portion of the side sill continue. Therefore, the vehicle lower body structure can efficiently transmit the side collision load from the one side sill to the other side sill.

The floor panel disposed between the upper member and the lower member, the upper member, and the lower member form the closed cross section in the front-rear direction vertical cross section. Therefore, in the vertical cross section along the vehicle front-rear direction, the cross-sectional area of the floor cross member, which functions as a load transmission member in the vehicle width direction transmitting the side collision load from the one side sill to the other side sill, can be increased to be larger than a cross-sectional area of a floor cross member that is only formed by the upper member fixed to the floor panel upper surface.

As a result, in the vertical cross section along the vehicle front-rear direction, cross-sectional strength of the floor cross member, which functions as the transmission member transmitting the side collision load from the one side sill to the other side sill, is increased, and the collision load can efficiently be transmitted from the one side sill to the other side sill. Therefore, in the vehicle lower body structure in which the floor panel is joined to the portion of the side sill located higher than the center position thereof in the vehicle up-down direction, the desired side collision performance can be ensured.

As an aspect of the disclosure, the upper member has three or more upper member ridgeline portions located at intervals in the vehicle front-rear direction, each of the upper member ridgeline portions extending in the vehicle width direction.

According to the disclosure, since the three or more upper ridgeline portions with higher rigidity than the other portions are provided in the upper member, cross-sectional strength of the upper member can further be increased. Accordingly, it is possible to further increase the cross-sectional strength of the floor cross member, which forms the closed cross section by the upper member with the further increased cross-sectional strength and the lower member via the floor panel. Therefore, the vehicle lower body structure can improve the function as the load transmission member in the vehicle width direction.

In addition, as an aspect of the disclosure, the lower member includes three or more lower member ridgeline portions located at intervals in the vehicle front-rear direction, each of the lower member ridgeline portions extending in the vehicle width direction.

According to the disclosure, since the three or more lower ridgeline portions with higher rigidity than the other portions are provided in the lower member, cross-sectional strength of the lower member can further be increased. Accordingly, it is possible to further increase the cross-sectional strength of the floor cross member, which forms the closed cross section by the upper member and the lower member with the further increased cross-sectional strength via the floor panel. Therefore, the vehicle lower body structure can further improve the function as the load transmission member in the vehicle width direction.

As an aspect of the disclosure, the floor cross member may have joint portions provided at opposing ends in the vehicle width direction and joined to the side sill and a body portion between the joint portions on both sides in the vehicle width direction, the upper member constituting the body portion may have: upper convex portions protruding upward in the vehicle, disposed at intervals in the vehicle front-rear direction, and each having the cross member upper surface; and an upper concave portion coupling the upper convex portions in the vehicle front-rear direction and disposed lower in the vehicle than the cross member upper surface, in the front-rear direction vertical cross section, the upper convex portions are disposed at intervals, the lower member constituting the body portion may have: lower convex portions protruding downward in the vehicle and disposed at intervals in the vehicle front-rear direction; and a lower concave portion coupling the lower convex portions in the vehicle front-rear direction, disposed higher in the vehicle than lower ends of the lower convex portions, and having a concave shape, in the vertical cross section along the vehicle front-rear direction, the lower convex portions are disposed at intervals, and the upper member and the lower member may be joined by the upper concave portion and the lower concave portion.

The above-described joint portions provided at both ends in the vehicle width direction and joined to the side sill may be a part of the floor cross member continuous with the body portion, or may be a seat attachment bracket or a gusset provided at both ends.

According to the disclosure, the cross-sectional strength of the floor cross member can further be increased. More specifically, the joint portions provided at both ends in the vehicle width direction and joined to the side sill, and the body portion between the joint portions on both sides in the vehicle width direction are provided. The upper member constituting the body portion has: the upper convex portions protruding upward in the vehicle, disposed at intervals in the vehicle front-rear direction, and each having the cross member upper surface; and the upper concave portion coupling the upper convex portions in the vehicle front-rear direction and disposed lower in the vehicle than the cross member upper surfaces. In the front-rear direction vertical cross section, the upper convex portions, which are disposed at intervals, and the upper concave portion may be formed to have a substantially M-shaped cross section. Thus, the upper member is formed with the at least six upper ridgeline portions extending in the vehicle width direction at intervals in the vehicle front-rear direction. In this way, the upper member having high cross-sectional strength can be formed while a height thereof in the vehicle up-down direction is set to be low.

The lower member constituting the body portion has: the lower convex portions protruding downward in the vehicle and disposed at intervals in the vehicle front-rear direction; and the lower concave portion coupling the lower convex portions in the vehicle front-rear direction, disposed higher in the vehicle than the lower ends of the lower convex portions, and having the concave shape. In the front-rear direction vertical cross section, the lower convex portions, which are disposed at intervals, and the lower concave portion may be formed to have a substantially inverted M-shaped cross section. Thus, the lower member is formed with the at least six lower ridgeline portions extending in the vehicle width direction at intervals in the vehicle front-rear direction. In this way, the lower member having high cross-sectional strength can be formed while a height thereof in the vehicle up-down direction is set to be low.

Furthermore, the upper member and the lower member are joined to each other by the upper concave portion and the lower concave portion. In this way, in the floor cross member, which forms the closed cross section via the floor panel, the upper convex portions and the lower convex portions, each pair of which is provided at the predetermined intervals in the vehicle front-rear direction, can form the closed cross section. Accordingly, it is possible to form the two closed cross sections in the floor cross member formed by the upper member and the lower member and to further increase the cross-sectional strength of the floor cross member. Therefore, the vehicle lower body structure can further improve the function as the load transmission member in the vehicle width direction.

In an aspect of the disclosure, the floor panel may be provided with a floor convex portion extending along the vehicle width direction and protruding to either side of the vehicle up-down direction, the upper concave portion, the floor convex portion, and the lower concave portion may be aligned in the vehicle up-down direction, and the upper member and the lower member may be joined by the upper concave portion and the lower concave portion via the floor convex portion. The above-described floor convex portion protruding to either side of the vehicle up-down direction may protrude upward in the vehicle or may protrude downward in the vehicle.

According to the disclosure, the floor convex portion is provided in the floor panel, extends along the vehicle width direction, and protrudes to either side of the vehicle up-down direction. The upper concave portion, the floor convex portion, and the lower concave portion are superimposed in the vehicle up-down direction, and the upper member and the lower member are joined by the upper concave portion and the lower concave portion via the floor convex portion.

Thus, compared to a case where the floor cross member having the closed cross section is formed by superimposing the upper concave portion and the lower concave portion with the flat floor panel being sandwiched therebetween, it is possible to secure a cross-sectional height of the floor cross member that forms the closed cross section while suppressing the protruding height of the upper convex portion or the lower convex portion in the direction opposite to the direction in which the floor convex portion protrudes with respect to the floor panel.

Thus, it is possible to further improve the cross-sectional strength of the floor cross member formed by the upper member and the lower member. Therefore, the vehicle lower body structure can further improve the function as the load transmission member in the vehicle width direction.

As an aspect of the disclosure, the upper member and the lower member may each be provided with a flange portion extending along the vehicle width direction and protruding in the vehicle front-rear direction, and the upper member and the lower member may be joined to the floor panel by the flange portions.

According to the disclosure, the upper member and the lower member can firmly be fixed to the floor panel by the flange portions. Therefore, the floor cross member, in which the floor panel is sandwiched between the upper member and the lower member, can reliably form the closed cross section.

As an aspect of the disclosure, a plurality of beads extending in the vehicle front-rear direction may be formed at intervals in the vehicle width direction on the flange portion formed along the vehicle width direction. According to the disclosure, it is possible to improve shape retainability of the flange portion formed to be long in the vehicle width direction. Therefore, it is possible to improve shape retainability of the upper member and the lower member, each of which has the flange portions.

As an aspect of the disclosure, the floor cross member may include: a first floor cross member disposed proximal a center position in the vehicle front-rear direction on the floor panel; and a second floor cross member disposed on a vehicle rear side at a predetermined distance from the first floor cross member.

According to the disclosure, it is possible to provide the floor cross member, which forms the closed cross section by sandwiching the floor panel, at two positions at the predetermined interval in the vehicle front-rear direction. Thus, it is possible to improve transmission performance of the collision load during the side collision in the vehicle width direction by the floor cross member. Therefore, in the vehicle lower body structure in which the floor panel is joined to the portion of the side sill located higher than the center position thereof in the vehicle up-down direction, the desired side collision performance can be ensured.

According to the disclosure, it is possible to provide the vehicle lower body structure capable of ensuring the desired side collision performance even when the floor panel is joined to the portion of the side sill located higher than the center position in the vehicle up-down direction.

### BRIEF DESCRIPTION OF THE DRAWINGS

FIG. 1 is an external perspective view illustrating external appearance of a vehicle lower body as viewed from the front of a vehicle.

FIG. 2 is a plan view illustrating the external appearance of the vehicle lower body in a plan view.

FIG. 3 is a plan view illustrating the external appearance of the vehicle lower body in a bottom view.

FIG. 4 is a cross-sectional view of a main section that is taken along an arrow A-A in FIG. 2.

FIG. 5 is a cross-sectional view of the main section that is taken along an arrow B-B in FIG. 2.

FIG. 6 is a cross-sectional view of the main section that is taken along an arrow C-C in FIG. 2.

FIG. 7 is a cross-sectional view of the main section that is taken along an arrow D-D in FIG. 2.

FIG. 8 is a schematic cross-sectional view of a bead formed in a concave portion and a flange portion as viewed from a vehicle front-rear direction.

### DETAILED DESCRIPTION

An embodiment of the disclosure will be described below with reference to the drawings.

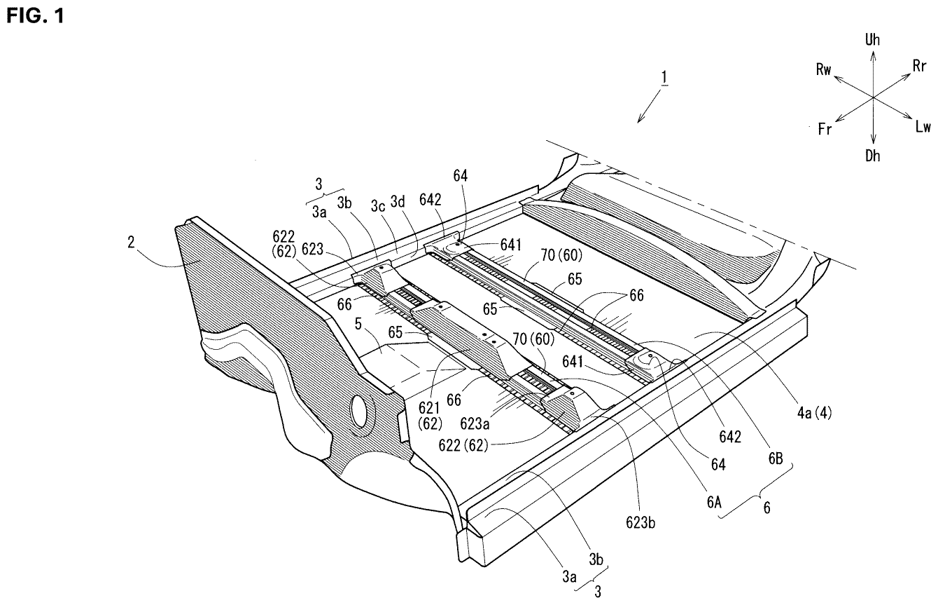

A vehicle 1 in the present embodiment is, for example, an electric vehicle in which a front floor panel 4 is joined to a portion of a side sill 3 above a center position in a vehicle up-down direction. A lower body structure in a cabin portion of such a vehicle 1 will be described in detail with reference to FIG. 1 to FIG. 8.

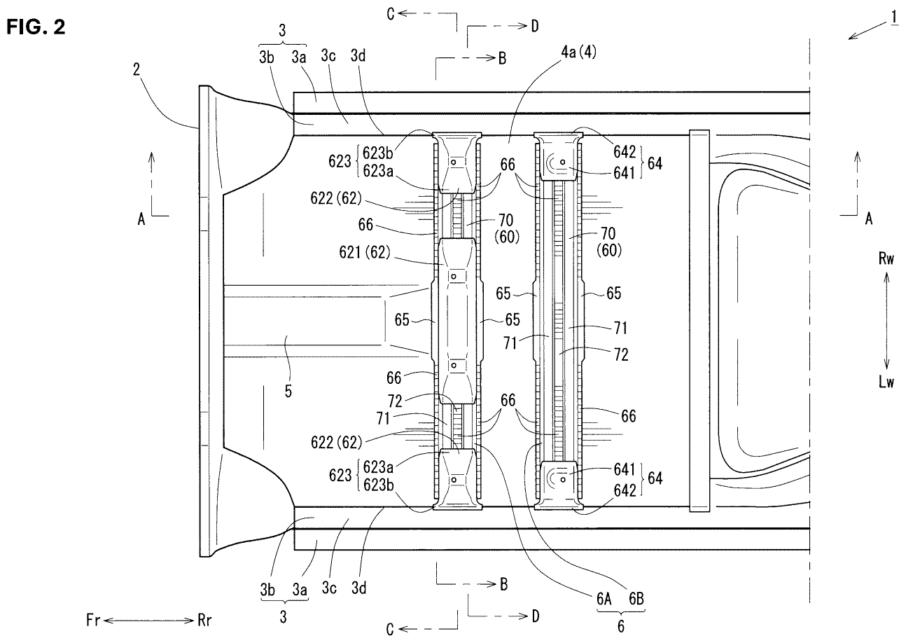

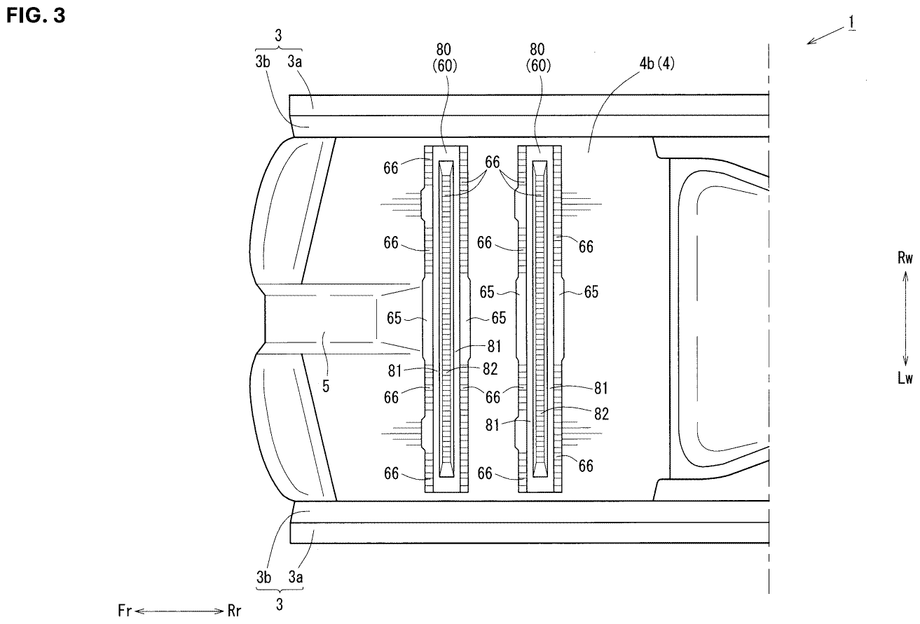

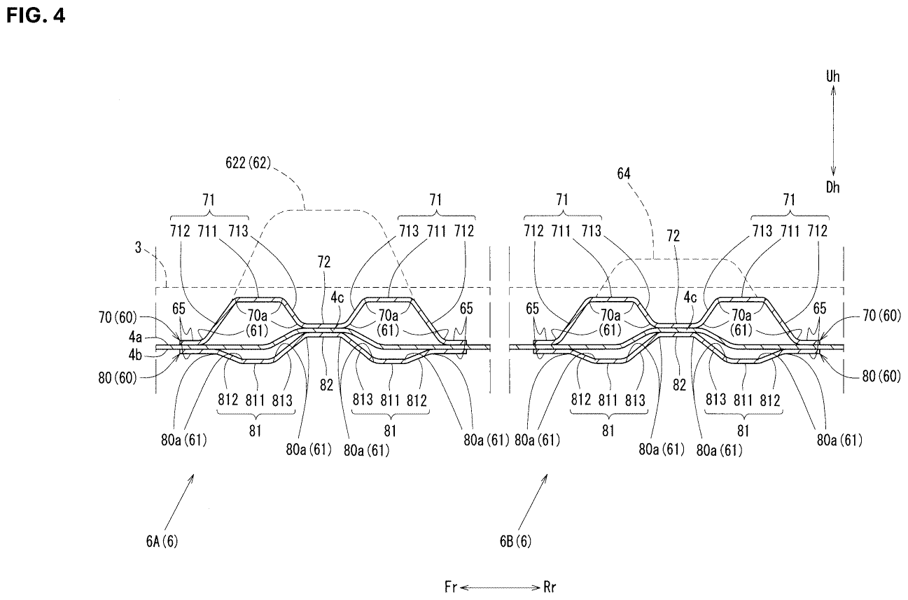

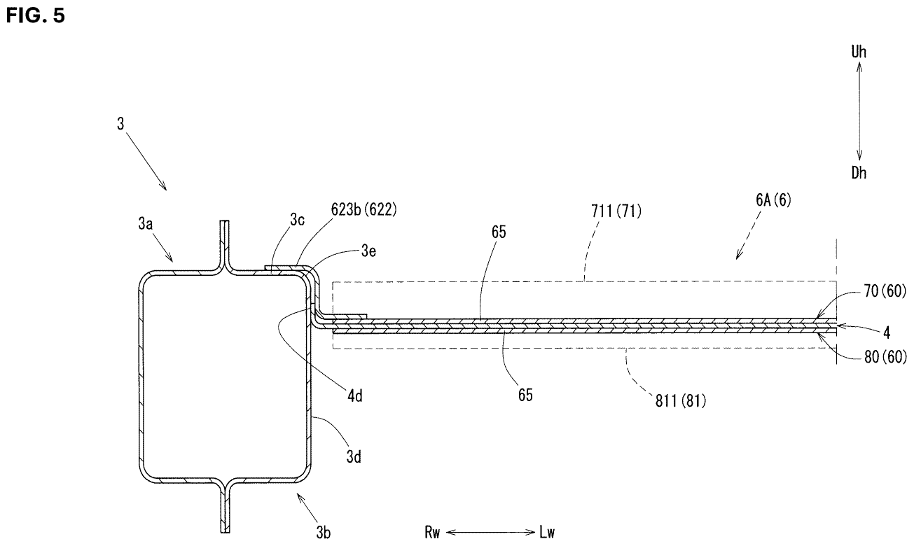

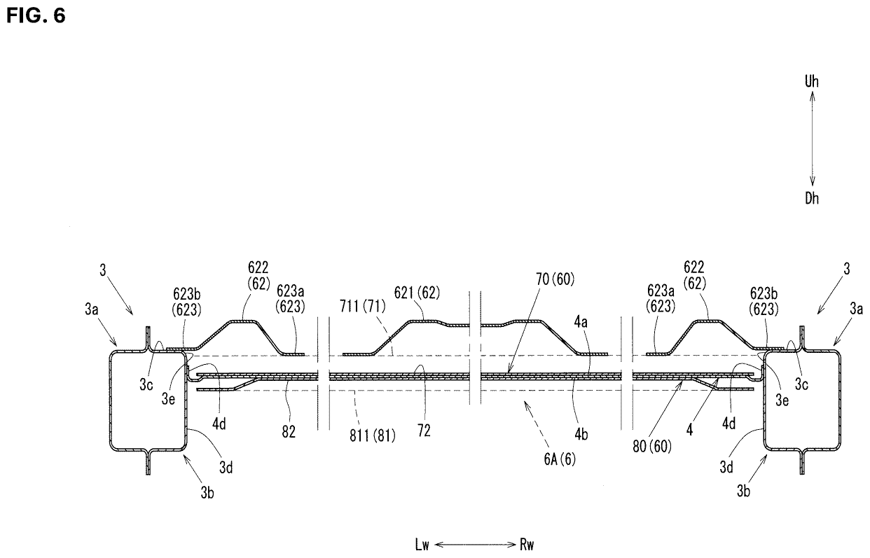

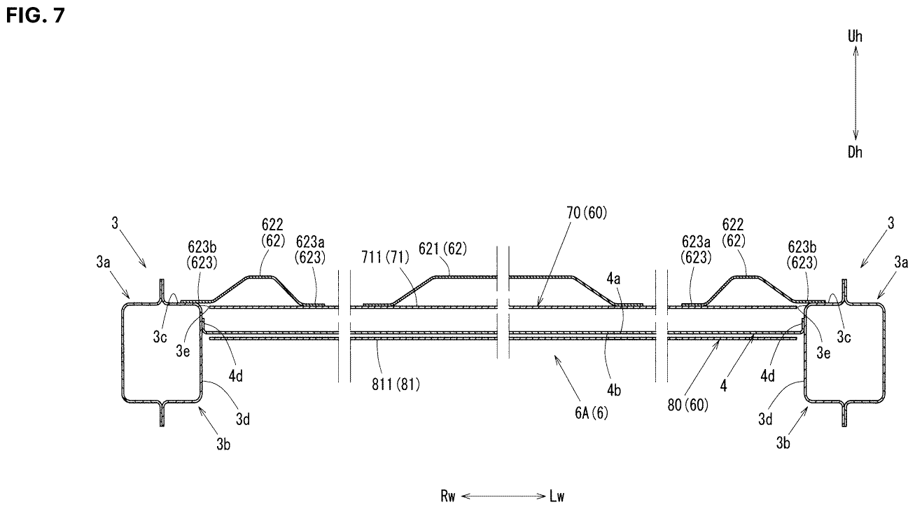

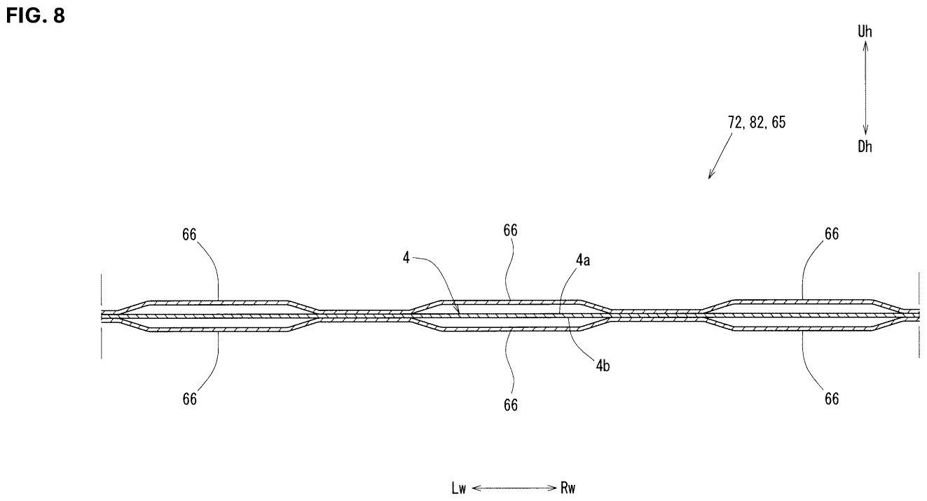

Here, FIG. 1 is an external perspective view of a lower body of the vehicle 1 as viewed from the front of the vehicle, FIG. 2 is a plan view of the lower body of the vehicle 1, FIG. 3 is a bottom view of the lower body of the vehicle 1, FIG. 4 is an enlarged cross-sectional view of a main section that is taken along an arrow A-A in FIG. 2, FIG. 5 is an enlarged cross-sectional view of the main section that is taken along an arrow B-B in FIG. 2, FIG. 6 is an enlarged cross-sectional view of the main section that is taken along an arrow C-C in FIG. 2, FIG. 7 is an enlarged cross-sectional view of the main section that is taken along an arrow D-D in FIG. 2, and FIG. 8 is a schematic cross-sectional view of concave portions 72, 82 and a bead 66 formed in a flange portion 65 as viewed in a vehicle front-rear direction.

In detail, FIG. 4 is the enlarged cross-sectional view of a portion, where a first floor cross member 6A and a second floor cross member 6B are disposed, taken along the arrow A-A extending in the vehicle front-rear direction in FIG. 2, and illustrates a side sill 3 and a front seat bracket 62 in broken lines.

FIG. 5 is the enlarged cross-sectional view of the vicinity of the right side sill 3 in a vehicle width direction that is taken along the arrow B-B extending in the vehicle width direction in FIG. 2, and illustrates the first floor cross member 6A by a broken line. FIG. 6 is the enlarged cross-sectional view of both end portions and a center portion in the vehicle width direction taken along the arrow C-C extending in the vehicle width direction in FIG. 2, and illustrates the first floor cross member 6A by a broken line. FIG. 7 is the enlarged cross-sectional view of both end portions and a center portion in the vehicle width direction taken along the arrow D-D extending in the vehicle width direction in FIG. 2.

In the drawings, the arrows Fr and Rr indicate the front-rear direction, arrow Fr indicates a front direction, and arrow Rr indicates a rear direction. Arrows Rw and Lw indicate the vehicle width direction, an arrow Rw indicates a right direction, and an arrow Lw indicates a left direction. Furthermore, arrows Uh and Dh indicate a vehicle up-down direction, an arrow Uh indicates a vehicle up direction, and an arrow Dh indicates a vehicle down direction.

As illustrated in FIGS. 1 and 2, the lower body of the vehicle 1 includes: a dashboard 2 that separates an engine room and the cabin in the vehicle front-rear direction; a pair of the left and right side sills 3 that extends rearward in the vehicle from lower portions at both ends of the dashboard 2 in the vehicle width direction; and the front floor panel 4 that is disposed between the left and right side sills 3 and forms a cabin floor surface.

As illustrated in FIGS. 1 and 2, in the front floor panel 4, a tunnel portion 5 that bulges substantially in a tunnel shape and extends rearward from the front of the vehicle is formed near a substantial center in the vehicle width direction. In addition, as illustrated in FIGS. 1 and 2, a floor cross member 6 coupling the pair of left and right side sills 3 in the vehicle width direction is fixed to the front floor panel 4 in the lower body of the vehicle 1. A battery unit (not illustrated) is disposed on the lower side of the front floor panel 4.

The lower body of the vehicle 1 includes a first floor cross member 6A and a second floor cross member 6B as the floor cross members 6 coupling the left and right side sills 3 in the vehicle width direction, the first floor cross member 6A is disposed substantially at the center of the front floor panel 4 in the vehicle front-rear direction, and the second floor cross member 6B is disposed on the vehicle rear side with a predetermined distance from the first floor cross member 6A.

Each configuration will be described in detail below.

The dash panel 2 is a panel member having a thickness in the vehicle front-rear direction, and is formed in a shape in which a lower portion thereof is curved rearward in the vehicle. The front floor panel 4 is provided from a lower end of this dash panel 2 toward the rear of the vehicle.

The side sills 3 are provided as the left and right pair extending rearward in the vehicle from a lower portion at both ends of the dash panel 2 in the vehicle width direction, and is configured such that a vertical cross section along the vehicle width direction (hereinafter referred to as a width direction vertical cross section) forms a closed cross section having a substantially rectangular cross section.

More specifically, in the width direction vertical cross section, the side sill 3 is formed in a substantially rectangular shape slightly longer in the vehicle up-down direction than in the vehicle width direction by assembling, in the width direction, a side sill outer 3a having a substantially hat-shaped cross section protruding outward in the vehicle width direction and a side sill inner 3b having a substantially hat-shaped cross section protruding inward in the vehicle width direction. An upper surface of the side sill 3 having a substantially rectangular cross-sectional shape in the vehicle width direction is defined as a side sill upper surface 3c. In addition, a surface of the side sill 3 along the vehicle up-down direction is defined as a side surface 3d, and a side sill ridgeline portion 3e is formed at a corner portion between the side sill upper surface 3c and the side surface 3d.

As illustrated in FIGS. 1 to 5, the front floor panel 4 is a substantially flat panel member having a thickness in the vehicle up-down direction, and its front end is coupled to the lower end of the dash panel 2, and a portion on the vehicle front side of the front floor panel 4 is inclined upward to the front of the vehicle toward the dash panel 2.

A surface facing the vehicle upper side of the front floor panel 4 is defined as a floor panel upper surface 4a, and a surface facing the vehicle lower side of the front floor panel 4 is defined as a floor panel lower surface 4b.

In addition, the tunnel portion 5, which protrudes upward in the vehicle and will be described below, is formed substantially at the center of the front floor panel 4 in the vehicle width direction.

In the tunnel portion 5, an end portion thereof on the vehicle front side is joined to the dash panel 2, and an end portion thereof on the vehicle rear side is formed to the front of the first floor cross member 6A, which will be described later, in the vehicle.

Furthermore, at two positions in the front floor panel 4 that are a substantially center position in the vehicle front-rear direction and a position on the vehicle rear side at a predetermined distance, a floor convex portion 4c (see FIG. 4) having a convex shape in the vehicle up direction is formed.

In addition, at each end of the front floor panel 4 in the vehicle width direction, a joint piece portion 4d bent in the vehicle up direction and joined to the side surface 3d of the side sill 3 is provided.

As illustrated in FIGS. 5 to 7, in the thus-configured front floor panel 4, the joint piece portion 4d of the front floor panel 4 abuts, is joined, and is fixed to the inner side surface 3d in the vehicle width direction of the side sill 3, whose cross section in the vehicle width direction is formed in a substantially rectangular shape slightly longer in the vehicle up-down direction than the vehicle width direction. At this time, the front floor panel 4 is fixed to be located above the vehicle upper side of a center position of the side sill 3, which is formed in a substantially rectangular shape slightly longer in the vehicle up-down direction than the vehicle width direction, in the vehicle up-down direction.

The floor cross member 6 includes: seat brackets 622, 64 provided at both ends in the vehicle width direction and joined to the side sill 3; and a body portion 60 constituting a portion between the seat brackets 62, 64, and couples the left and right side sills 3 in the vehicle width direction. In addition, the body portion 60 of the floor cross member 6 is formed with a plurality of cross member ridge portions 61 extending in the vehicle width direction.

The body portion 60 of the floor cross member 6 configures an upper member 70 and a lower member 80 by holding the front floor panel 4 therebetween in the vehicle up-down direction, the upper member 70 having a substantially M-shaped cross section, fixed to the floor panel upper surface 4a of the front floor panel 4, and extending in the vehicle width direction, and the lower member 80 having a substantially inverted M-shaped cross section, fixed to the floor panel lower surface 4b of the front floor panel 4, and extending in the vehicle width direction.

As illustrated in FIG. 4, the upper member 70 having the substantially M-shaped cross section is formed with upper member ridgeline portions 70a constituting a plurality of cross-member ridgeline portions 61, which extends in the vehicle width direction, at predetermined intervals in the vehicle front-rear direction, and is formed to have an open cross section in a substantially inverted concave shape, which is opened downward in the vehicle, in the front-rear direction vertical cross section.

In detail, the upper member 70 includes, in the front-rear direction vertical cross section: upper convex portions 71 disposed at a predetermined interval in the vehicle front-rear direction and protruding in the vehicle up direction; an upper concave portion 72 disposed between the upper convex portions 71 and disposed on the vehicle lower side of a cross member upper surface 711 of each of the upper convex portions 71; and the flange portion 65 protruding in the vehicle front-rear direction from a lower end of an outer surface 712 of the respective upper convex portion 71.

The upper convex portion 71 includes, in the front-rear direction vertical cross section: the cross member upper surface 711 that is substantially horizontal; the outer surface 712 extending downward and outward in the vehicle on an outer side of the cross member upper surface 711 in the vehicle front-rear direction; and an inner surface 713 extending downward and inward in the vehicle on an inner side of the cross member upper surface 711 in the vehicle front-rear direction. In addition, the flange portion 65 fixed to the floor panel upper surface 4a of the front floor panel 4 is provided at the lower end of the outer surface 712.

In a vertical cross section in the front-rear direction, the inner surface 713 is formed to have a shorter inclined length than that of the outer surface 712. More specifically, in the cross section in the front-rear direction, the inner surface 713 is formed to have the length of about half the length of the outer surface 712.

In the front-rear direction vertical cross section, the upper concave portion 72 is formed to be substantially horizontal in a manner to couple lower ends of the inner surfaces 713 of the cross member upper surfaces 711, which are provided on both sides in the vehicle front-rear direction, to each other in the vehicle front-rear direction. Thus, the upper concave portion 72 is disposed lower in the vehicle than the cross member upper surface 711 of the upper convex portion 71 and is disposed higher in the vehicle than the flange portion 65.

As illustrated in FIG. 2, a plurality of beads 66 (see FIG. 8) protruding upward in the vehicle and extending in the vehicle front-rear direction is formed at intervals in the vehicle width direction in the upper concave portion 72, which is formed between the upper convex portions 71, and the flange portion 65. More specifically, the bead 66 is formed in a range of about ⅓ of both sides in the vehicle width direction on the flange portion 65 extending in the vehicle width direction. In addition, the bead 66 is slightly formed in a range of about ⅓ of both sides in the vehicle width direction and a center portion in the upper concave portion 72 extending in the vehicle width direction.

The upper member 70 formed as described above is formed with the upper member ridgeline portion 70a (the cross member ridge portion 61), which extends in the vehicle width direction, at a corner portion between the cross member upper surface 711 and the outer surface 712, a corner portion between the cross member upper surface 711 and the inner surface 713, a corner portion between the outer surface 712 and the flange portion 65, and a corner portion between the inner surface 713 and the upper concave portion 72, and is formed to be substantially M-shaped when viewed in the vehicle width direction.

As illustrated in FIG. 4, the lower member 80 having the substantially inverted M-shaped cross section is formed with lower member ridgeline portions 80a constituting the plurality of cross member ridge portions 61, which extends in the vehicle width direction, at predetermined intervals in the vehicle front-rear direction, and is formed to have the substantially concave open cross section that is opened upward in the vehicle in the front-rear direction vertical cross section.

In detail, in the front-rear direction vertical cross section, lower convex portions 81, a lower concave portion 82, and the flange portions 65 are provided. The lower convex portions 81 are disposed at a predetermined interval in the vehicle front-rear direction and protrude in the vehicle up direction, the lower concave portion 82 is disposed between the lower convex portions 81 and is disposed to be higher in the vehicle than the cross member bottom surfaces 811 of the lower convex portions 81, and the flange portions 65 each protrude in the vehicle front-rear direction from an upper end of an outer surface 812 of the respective lower convex portion 81.

The lower convex portion 81 includes, in the front-rear direction vertical cross section: the cross member bottom surface 811 that is substantially horizontal; the outer surface 812 extending upward and outward in the vehicle on an outer side of the cross member bottom surface 811 in the vehicle front-rear direction; and an inner surface 813 extending upward and inward in the vehicle on an inner side of the cross member bottom surface 811 in the vehicle front-rear direction. In addition, the flange portion 65 fixed to the floor panel lower surface 4b of the front floor panel 4 is provided at an upper end of the outer surface 812.

In the vertical cross section in the front-rear direction, the inner surface 813 is formed to have a longer inclined length than that of the outer surface 812. More specifically, in the cross section in the front-rear direction, the inner surface 813 is formed to have the length of about twice the length of the outer surface 812.

In the front-rear direction vertical cross section, the lower concave portion 82 is formed to be substantially horizontal in a manner to couple upper ends of the inner surfaces 813 of the cross member bottom surfaces 811, which are provided on both sides in the vehicle front-rear direction, to each other in the vehicle front-rear direction. Thus, the lower concave portion 82 is disposed higher in the vehicle than the flange portion 65, which is disposed higher in the vehicle than the cross member bottom surface 811 of the lower convex portion 81.

As illustrated in FIG. 3, a plurality of the beads 66 (see FIG. 8) protruding downward in the vehicle and extending in the vehicle front-rear direction is formed at intervals in the vehicle width direction in the lower concave portion 82, which is formed between the lower convex portions 81, and the flange portions 65. More specifically, the beads 66 are formed in a range of the flange portion 65, which extends in the vehicle width direction, except for about ¼ of a center portion in the vehicle width direction. Meanwhile, in the lower concave portion 82 extending in the vehicle width direction, the beads 66 are formed in an entire range in the vehicle width direction.

The lower member 80 formed as described above is formed with the lower member ridgeline portion 80a (the cross member ridge portion 61), which extends in the vehicle width direction, at a corner portion between the cross member bottom surface 811 and the outer surface 812, a corner portion between the cross member bottom surface 811 and the inner surface 813, a corner portion between the outer surface 812 and the flange portion 65, and a corner portion between the inner surface 813 and the lower concave portion 82, and is formed in a substantially inverted M-shape when viewed in the vehicle width direction.

In regard to the upper member 70 and the lower member 80 formed as described above, the upper member 70 is disposed on the vehicle upper side of the front floor panel 4, and the lower member 80 is disposed on the vehicle lower side of the front floor panel 4 in a manner to correspond to the upper member 70 in the vehicle up-down direction. That is, the upper member 70 and the lower member 80 are disposed and fixed to hold the front floor panel 4 from both sides in the vehicle up-down direction, and thereby constitute the floor cross member 6.

In detail, as illustrated in FIG. 4, the upper member 70 and the lower member 80 are disposed such that the upper concave portion 72 and the lower concave portion 82 are positioned for the floor convex portion 4c, which extends in the vehicle width direction and protrudes in the vehicle up direction, in the front floor panel 4.

Then, the flange portions 65 of the upper member 70 disposed on the floor panel upper surface 4a of the front floor panel 4 and the flange portions 65 of the lower member 80 disposed on the floor panel lower surface 4b of the front floor panel 4 are joined to each other while holding the front floor panel 4 therebetween. At this time, the upper concave portion 72 of the upper member 70, the floor convex portion 4c of the front floor panel 4, and the lower concave portion 82 of the lower member 80 are superimposed in the vehicle up-down direction. The upper concave portion 72 of the upper member 70 and the lower concave portion 82 of the lower member 80, which are superimposed just as described, are joined to each other while holding the floor convex portion 4c of the front floor panel 4 therebetween.

In this way, the front floor panel 4, the upper member 70, and the lower member 80 are fixed, and the floor cross member 6 that forms the closed cross section while sandwiching the front floor panel 4 can be formed. More specifically, the closed cross section is formed in a state where the upper convex portion 71 and the lower convex portion 81 on one side in the vehicle front-rear direction sandwich the front floor panel 4 in the vehicle up-down direction. Then, the closed cross section is formed in a state where the upper convex portion 71 and the lower convex portion 81 on the other side in the vehicle front-rear direction sandwich the front floor panel 4 in the vehicle up-down direction. That is, the closed cross section formed by the upper convex portion 71 and the lower convex portion 81 is formed on each side in the vehicle front-rear direction of the upper concave portion 72, the floor convex portion 4c, and the lower concave portion 82, which are superimposed and fixed to each other in the vehicle up-down direction.

Here, as illustrated in FIG. 4, in the vertical cross section in the front-rear direction, a distance in the vehicle up-down direction between the front floor panel 4 and cross member bottom surface 811 is shorter than a distance in the vehicle up-down direction between the front floor panel 4 and the cross member upper surface 711. That is, a protruding height of the floor cross member 6 in the vehicle down direction from the floor panel lower surface 4b can be less than a protruding height of the floor cross member 6 in the vehicle up direction from the floor panel upper surface 4a of the front floor panel 4. However, since the floor convex portion 4c, on which the upper concave portion 72 and the lower concave portion 82 are superimposed, is located higher in the vehicle than the other portions of the front floor panel 4, it is disposed at the approximately center position between the cross member upper surface 711 and the cross member bottom surface 811 in the vehicle front-rear direction.

In other words, the closed cross section of the floor cross member 6, which is formed by the upper convex portion 71 and the lower convex portion 81 sandwiching the front floor panel 4, is located close to the vehicle upper side with respect to the front floor panel 4 but protrudes to the same extent on both sides in the vehicle up-down direction with respect to the floor convex portion 4c, which is located at the center in the vehicle up-down direction of the floor cross member 6 and on which the upper concave portion 72 and the lower concave portion 82 are superimposed.

In addition, in the body portion 60, the joint portions among the flange portions 65 of the upper member 70 and the lower member 80 and the front floor panel 4 are disposed at intervals in the vehicle front-rear direction, and the joint portion among the upper concave portion 72, the lower concave portion 82, and the floor convex portion 4c is disposed therebetween. Then, since the floor convex portion 4c protrudes higher in the vehicle than the front floor panel 4, in the vehicle up-down direction, the joint portion among the upper concave portion 72, the lower concave portion 82, and the floor convex portion 4c is located higher in the vehicle than the joint portion among the flange portions 65 of the upper member 70 and the lower member 80 and the front floor panel 4 disposed at the interval in the vehicle front-rear direction.

Here, cross-sectional strength of these joint portions of the body portion 60 in the front-rear direction vertical cross section is lower than that of the other portions. Accordingly, in the body portion 60 of the floor cross member 6, compared to a case where the joint portion among the upper concave portion 72, the lower concave portion 82 and the floor convex portion 4c is aligned with the joint portions among the flange portions 65 of the upper member 70 and the lower member 80 and the front floor panel 4 in the vehicle up-down direction disposed at intervals in the vehicle front-rear direction on a straight line in the vehicle front-rear direction, the joint portion among the upper concave portion 72, the lower concave portion 82, and the floor convex portion 4c is arranged on the vehicle upper side. In this way, the floor cross member 6 with high cross-sectional strength can be formed.

In addition, the upper convex portion 71 of the upper member 70 is fixed to the floor panel upper surface 4a of the front floor panel 4 fixed to the side sill 3, which is formed in the rectangular shape slightly longer in the vehicle front-rear direction than in the vehicle width direction, in the manner to be located higher in the vehicle than the center position thereof in the vehicle up-down direction, but the side sill upper surface 3c of the side sill 3 and the cross member upper surface 711 of the upper convex portion 71 are formed at approximately the same height in the vehicle up-down direction.

As described above, the floor cross members 6, each of which has the closed cross section formed by the upper member 70 and the lower member 80, include the first floor cross member 6A disposed near the center of the front floor panel 4 in the vehicle front-rear direction and the second floor cross member 6B disposed on the vehicle rear side at the predetermined interval from the first floor cross member 6A.

Of the floor cross members 6, the first floor cross member 6A on the vehicle front side includes the front seat brackets 62. The front seat brackets 62 include a front inner seat bracket 621 disposed at a center of the first floor cross member 6A in the vehicle width direction and front outer seat brackets 622 disposed on both outer sides.

The front inner seat bracket 621 has a substantial box shape that is long in the vehicle width direction and is opened downward in the vehicle, and is configured that an inner portion in the vehicle width direction of a vehicle front portion of the front seat in the vehicle width direction is attached to an upper surface of the front inner seat bracket 621. The front inner seat bracket 621 is fixed by being joined to the first floor cross member 6A by welding such as spot welding.

The front outer seat brackets 622 are disposed on both sides in the vehicle width direction of the first floor cross member 6A, and is configured to attach an outer portion in the vehicle width direction of the vehicle front portion of the front seat to an upper surface thereof. The front outer seat brackets 622 each have a substantial chevron shape when viewed from the vehicle front-rear direction, has a substantial box shape that is opened downward in the vehicle, and includes flange portions 623 (623a, 623b), each of which extends in the vehicle width direction, on both sides in the vehicle width direction. The front outer seat bracket 622 has ridgeline portions in an upper portion (see FIG. 4).

More specifically, the inner flange portion 623a, which is formed in a substantially chevron shape when viewed in the vehicle front-rear direction, on the inner side in the vehicle width direction of the front outer seat bracket 622 is joined and fixed to the cross member upper surface 711 of the upper member 70 constituting the first floor cross member 6A.

Meanwhile, the outer flange portion 623b, which is formed in a substantially chevron shape when viewed in the vehicle front-rear direction, on the outer side in the vehicle width direction of the front outer seat bracket 622 is joined and fixed to the side sill upper surface 3c of the side sill 3.

Just as described, the first floor cross member 6A is joined to the side sill 3 via the front outer seat bracket 622 having the inner flange portion 623a, which is joined and fixed to the cross member upper surface 711 of the upper member 70, and the outer flange portion 623b, which is joined and fixed to the side sill upper surface 3c of the side sill 3.

Of the floor cross members 6, the second floor cross member 6B on the vehicle rear side includes the rear outer seat bracket 64. The rear outer seat bracket 64 is disposed on both outer sides in the vehicle width direction of the second floor cross member 6B. The rear outer seat bracket 64 is disposed on both sides in the vehicle width direction of the second floor cross member 6B and is configured to attach an outer portion in the vehicle width direction of a vehicle rear portion of the front seat to the upper surface thereof. Here, a rear inner seat bracket for attaching an inner portion in the vehicle width direction of the vehicle rear portion of the front seat is not illustrated.

The rear outer seat bracket 64 has: a body portion 641 that has a substantially square shape in the plan view and is fixed to the upper convex portion 71 of the upper member 70 constituting the second floor cross member 6B; and a flange portion 642 that extends outward in the vehicle width direction from the body portion 641. Here, the rear outer seat bracket 64 has ridgeline portions in an upper portion thereof (see FIG. 4).

The body portion 641 is joined and fixed to the second floor cross member 6B by welding such as spot welding, and the flange portion 642 is joined and fixed to the side sill upper surface 3c of the side sill 3. Just as described, the second floor cross member 6B is joined to the side sill 3 via the rear outer seat bracket 64 having: the body portion 641 joined and fixed to the cross member upper surface 711 of the upper member 70; and the flange portion 642 joined and fixed to the side sill upper surface 3c of the side sill 3.

As described above, the cross member upper surface 711 of the upper member 70 constituting the first floor cross member 6A, which is joined to the side sill 3 via the front outer seat bracket 622, and the second floor cross member 6B, which is joined to the side sill 3 via the rear outer seat bracket 64, is located at substantially the same position as the side sill upper surface 3c of the side sill 3 in the vehicle up-down direction.

Thus, the upper member ridgeline portion 70a (the cross member ridgeline portion 61), which extends in the vehicle width direction in each of the first floor cross member 6A and the second floor cross member 6B, continues with the side sill ridgeline portion 3e, which is formed at a corner portion between the side sill upper surface 3c and the side surface 3d of the side sill 3, via the ridgeline portion of the front outer seat bracket 622 and the ridgeline portion of the rear outer seat bracket 64.

In detail, the upper member ridgeline portion 70a (the cross member ridgeline portion 61), which is formed on both sides in the vehicle front-rear direction of the upper convex portion 71 of the upper member 70 constituting each of the floor cross members 6 (6A, 6B) connected to the side sill upper surface 3c of the side sill 3 via respective one of the front outer seat bracket 622 and the rear outer seat bracket 64, and the side sill ridgeline portion 3e, which is formed at the corner portion between the side sill upper surface 3c and the side surface 3d in the side sill 3, extend in different directions and are provided via each of the front outer seat bracket 622 and the rear outer seat bracket 64, but are located at substantially the same positions in the vehicle up-down direction and continue to each other via each of the front outer seat bracket 622 and the rear outer seat bracket 64.

As it has been described so far, the lower body structure of the vehicle 1 includes: the pair of left and right side sills 3 extending in the vehicle front-rear direction at both lateral ends in the vehicle width direction of the front floor panel 4; and the floor cross member 6 extending in the vehicle width direction and coupling the pair of left and right side sills. The side sill 3 has the side sill upper surface 3c facing upward in the vehicle and has the closed cross section in the vertical cross section along the vehicle width direction. The floor cross member 6 includes: the upper member 70 fixed to the floor panel upper surface 4a as the upper surface of the front floor panel 4, protruding in the vehicle up direction, and has the cross member upper surface 711 facing upward in the vehicle; and the lower member 80 fixed to the floor panel lower surface 4b as the lower surface of the front floor panel 4 and protrudes downward in the vehicle. The side sill 3 and the floor cross member 6 are joined to align the positions of the side sill upper surface 3c and the cross member upper surface 711 in the vehicle up-down direction, and form a closed cross section in the vertical cross section along the vehicle front-rear direction with the front floor panel 4 disposed between the upper member 70 and the lower member 80, the upper member 70, and the lower member 80.

With this configuration, it is possible to ensure desired side collision performance even when the front floor panel 4 is joined to the portion of the side sill 3 located higher than the center position thereof in the vehicle up-down direction. More specifically, the lower body structure of the vehicle 1 includes: the pair of left and right side sills extending in the vehicle front-rear direction at both lateral ends in the vehicle width direction of the front floor panel 4; and the floor cross member 6 extending in the vehicle width direction and coupling the pair of left and right side sills 3. The side sill 3 has the side sill upper surface 3c facing upward in the vehicle and has the closed cross section in the vertical cross section in the width direction.

In addition, the floor cross member 6 has: the upper member 70 that has the cross member upper surface 711 fixed to the floor panel upper surface 4a as the upper surface of the front floor panel 4, protruding upward in the vehicle, and facing upward in the vehicle; and the lower member 80 fixed to the floor panel lower surface 4b as the lower surface of the front floor panel 4 and protruding downward in the vehicle.

Then, the side sill 3 and the floor cross member 6 are joined in the manner to align the positions of the side sill upper surface 3c and the cross member upper surface 711 in the vehicle up-down direction. The side sill ridgeline portion 3e, which forms the side sill upper surface 3c in the side sill 3 and extends in the vehicle front-rear direction, and the cross member ridgeline portion 61 (the upper member ridgeline portion 70a), which forms the cross member upper surface 711 in the floor cross member 6 and extends in the vehicle width direction, have higher rigidity than the other portions in the respective members. Just as described, the ridgeline portions (3e, 61), the rigidity of which is high in the respective members, have the extending directions substantially orthogonal to each other in the plan view but are located at substantially the same positions in the vehicle up-down direction. That is, the cross member ridgeline portion 61 (the upper member ridgeline portion 70a) of the floor cross member 6 and the side sill ridgeline portion 3e of the side sill 3 continue. Therefore, the lower body structure of the vehicle 1 can efficiently transmit the side collision load from the one side sill 3 to the other side sill 3.

The front floor panel 4, which is disposed between the upper member 70 and the lower member 80, the upper member 70, and the lower member 80 form the closed cross section in the front-rear direction vertical cross section. Therefore, in the vertical cross section along the vehicle front-rear direction, a cross-sectional area of the floor cross member 6, which functions as the load transmission member in the vehicle width direction transmitting the side collision load from the one side sill 3 to the other side sill 3, can be increased to be larger than a cross-sectional area of a floor cross member that is only formed by the upper member fixed to the floor panel upper surface 4a.

Accordingly, the cross-sectional strength of the floor cross member 6, which functions as the transmission member for transmitting the side collision load from the one side sill 3 to the other side sill 3, in the front-rear direction vertical cross section is increased, and thus the collision load can efficiently be transmitted from the one side sill 3 to the other side sill 3. Therefore, in the lower body structure of the vehicle 1 in which the front floor panel 4 is joined to the portion of the side sill 3 located higher than the center position thereof in the vehicle up-down direction, the desired side collision performance can be ensured.

In the upper member 70, the ridgeline portion extending in the vehicle width direction is the upper member ridgeline portion 70a. The upper member 70 has the three or more upper member ridgeline portions 70a located at intervals in the vehicle front-rear direction. With this configuration, since the three or more upper ridgeline portions with higher rigidity than the other portions are provided in the upper member 70, the cross-sectional strength of the upper member 70 can further be increased.

Accordingly, it is possible to further increase the cross-sectional strength of the floor cross member 6, which forms the closed cross section by the upper member 70 with the further increased cross-sectional strength and the lower member 80 via the front floor panel 4. Therefore, the lower body structure of the vehicle 1 can improve the function as the load transmission member in the vehicle width direction.

In the lower member 80, the ridgeline portion extending in the vehicle width direction is the lower member ridgeline portions 80a. The lower member 80 has the three or more lower member ridgeline portions 80a located at intervals in the vehicle front-rear direction. With this configuration, since the three or more lower ridgeline portions with higher rigidity than the other portions are provided in the lower member 80, the cross-sectional strength of the lower member 80 can further be increased.

Accordingly, it is possible to further increase the cross-sectional strength of the floor cross member 6, which forms the closed cross section by the upper member 70 and the lower member 80 with the further increased cross-sectional strength via the front floor panel 4. Therefore, the lower body structure of the vehicle 1 can further improve the function as the load transmission member in the vehicle width direction.

The floor cross member 6 has: the seat brackets 622, 64 provided at both ends in the vehicle width direction and joined to the side sills 3; and the body portion 60 between each pair of the seat brackets 622, 64 on both sides in the vehicle width direction. The upper member 70 in the body portion 60 has: the upper convex portions 71 protruding upward in the vehicle, disposed at intervals in the vehicle front-rear direction, and having the cross member upper surfaces 711; and the upper concave portion 72 coupling the upper convex portions 71 in the vehicle front-rear direction disposed lower in the vehicle than the cross member upper surfaces 711. In the front-rear direction vertical cross section, the upper convex portions 71, which are disposed at intervals, and the upper concave portion 72 are formed to have the substantially M-shaped cross section. The lower member 80 in the body portion 60 has: the lower convex portions 81 protruding downward in the vehicle and disposed at intervals in the vehicle front-rear direction; and the lower concave portion 82 coupling the lower convex portions 81 in the vehicle front-rear direction, disposed higher in the vehicle than the lower ends of the lower convex portions 81, and having the concave shape. In the front-rear direction vertical cross section, the lower convex portions 81, which are disposed at intervals, and the lower concave portion 82 are formed to have the substantially inverted M-shaped cross section. Then, the upper member 70 and the lower member 80 are joined to each other by the upper concave portion 72 and the lower concave portion 82.

With this configuration, the cross-sectional strength of the floor cross member 6 can further be increased. More specifically, the front outer seat bracket 622 provided at both ends in the vehicle width direction and joined to the side sill 3 and the body portion 60 between the front outer seat brackets 622 on both sides in the vehicle width direction are provided. The body portion 60 in the upper member 70 has: the upper convex portions 71 protruding upward in the vehicle, disposed at intervals in the vehicle front-rear direction, and each having the cross member upper surface 711; and the upper concave portion 72 coupling the upper convex portions 71 in the vehicle front-rear direction and disposed lower in the vehicle than the cross member upper surface 711. In the front-rear direction vertical cross section, the upper convex portions 71, which are disposed at intervals, and the upper concave portion 72 are formed to have the substantially M-shaped cross section. Thus, the upper member 70 is formed with the at least six upper member ridgeline portions 70a extending in the vehicle width direction at intervals in the vehicle front-rear direction. In this way, the upper member 70 having high cross-sectional strength can be formed while the height thereof in the vehicle up-down direction is set to be low.

The lower member 80 in the body portion 60 has: the lower convex portions 81 protruding downward in the vehicle and disposed at intervals in the vehicle front-rear direction; and the lower concave portion 82 coupling the lower convex portions 81 in the vehicle front-rear direction, disposed higher in the vehicle than the lower ends of the lower convex portions 81, and having the concave shape. In the front-rear direction vertical cross section, the lower convex portions 81, which are disposed at intervals, and the lower concave portion 82 are formed to have the substantially inverted M-shaped cross section. Thus, the lower member 80 is formed with the at least six lower member ridgeline portions 80a extending in the vehicle width direction at intervals in the vehicle front-rear direction. In this way, the lower member 80 having high cross-sectional strength can be formed while the height thereof in the vehicle up-down direction is set to be low.

Furthermore, the upper member 70 and the lower member 80 are joined to each other by the upper concave portion 72 and the lower concave portion 82. In this way, in the floor cross member 6, which forms the closed cross section via the front floor panel 4, the upper convex portions 71 and the lower convex portions 81, each pair of which is provided at the predetermined intervals in the vehicle front-rear direction, can form the closed cross section. Accordingly, it is possible to form the two closed cross sections in the floor cross member 6 formed by the upper member 70 and the lower member 80 and to further increase the cross-sectional strength of the floor cross member 6. Therefore, the lower body structure of the vehicle 1 can further improve the function as the load transmission member in the vehicle width direction.

The front floor panel 4 is provided with the floor convex portion 4c extending along the vehicle width direction and protruding to either side of the vehicle up-down direction. The upper concave portion 72, the floor convex portion 4c, and the lower concave portion 82 are superimposed in the vehicle up-down direction. The upper member 70 and the lower member 80 are joined to each other by the upper concave portion 72 and the lower concave portion 82 via the floor convex portion 4c.

With this configuration, the upper concave portion 72, the floor convex portion 4c provided in the front floor panel 4, extending along the vehicle width direction, and protruding to either side of the vehicle up-down direction, and the lower concave portion 82 are superimposed in the vehicle up-down direction. The upper member 70 and the lower member 80 are joined to each other by the upper concave portion 72 and the lower concave portion 82 via the floor convex portion 4c.

Thus, compared to a case where the floor cross member 6 having the closed cross section is formed by superimposing the upper concave portion 72 and the lower concave portion 82 with the flat front floor panel 4 being sandwiched therebetween, it is possible to secure a cross-sectional height of the floor cross member 6 that forms the closed cross section while suppressing the protruding height of the lower convex portion 81 in the vehicle down direction, which is opposite to the protruding direction of the floor convex portion 4c, with respect to the front floor panel 4.

Therefore, it is possible to further improve the cross-sectional strength of the floor cross member 6 formed by the upper member 70 and the lower member 80. Therefore, the lower body structure of the vehicle 1 can further improve the function as the load transmission member in the vehicle width direction.

The upper member 70 and the lower member 80 are each provided with the flange portions 65 extending along the vehicle width direction and protruding in the vehicle front-rear direction, and the upper member 70 and the lower member 80 are joined to the front floor panel 4 by the flange portions 65.

With this configuration, the upper member 70 and the lower member 80 can firmly be fixed to the front floor panel 4 by the flange portions 65. Therefore, the floor cross member 6, in which the front floor panel 4 is sandwiched between the upper member 70 and the lower member 80, can reliably form the closed cross section.

In each of the flange portions 65 formed along the vehicle width direction, the plurality of beads 66 extending in the vehicle front-rear direction is formed at intervals in the vehicle width direction. Thus, shape retainability of the flange portions 65 formed to be long in the vehicle width direction can be improved. Therefore, it is possible to improve shape retainability of the upper member 70 and the lower member 80, each of which has the flange portions 65.

In each of the concave portions 72, 82 formed along the vehicle width direction, the plurality of beads 66 extending in the vehicle front-rear direction is formed at intervals in the vehicle width direction. Thus, shape retainability of the concave portions 72, 82 formed to be long in the vehicle width direction can be improved. Therefore, it is possible to improve the shape retainability of the upper member 70 and the lower member 80 having the concave portions 72, 82 formed with the beads 66.

The floor cross member 6 includes: the first floor cross member 6A disposed at the substantially center position in the vehicle front-rear direction on the front floor panel 4; and the second floor cross member 6B disposed on the vehicle rear side at the predetermined distance from the first floor cross member 6A.

With this configuration, it is possible to provide the floor cross member 6, which forms the closed cross section by sandwiching the front floor panel 4, at two positions at the predetermined interval in the vehicle front-rear direction. Thus, it is possible to improve the transmission performance of the collision load during the side collision in the vehicle width direction by the floor cross member 6. Therefore, in the lower body structure of the vehicle 1 in which the front floor panel 4 is joined to the portion of the side sill 3 located higher than the center position thereof in the vehicle up-down direction, the desired side collision performance can be ensured.

In correspondence between the configuration in the disclosure and the above-described embodiment, the floor panel in the disclosure corresponds to the front floor panel 4. Hereinafter, similarly, the joint portion corresponds to the front outer seat bracket 622. However, the disclosure is not limited only to the configuration in the above-described embodiment, and many embodiments can be obtained.

For example, in the above-described embodiment, the first floor cross member 6A is joined to the side sills 3 via the front outer seat brackets 622 provided on both sides in the vehicle width direction, and the second floor cross member 6B is joined to the side sills 3 via the rear outer seat brackets 64 provided on both sides in the vehicle width direction. However, each thereof may be joined to the side sills 3 via the gussets provided on both sides in the vehicle width direction of the body portion 60, or both end portions of the body portion 60 may directly be joined to the side sills 3. Furthermore, the cross member upper surface 711 of the upper member 70 constituting the body portion 60 may extend outward in the vehicle width direction and may be joined to the side sill upper surface 3c of the side sill 3.

The above-described side sill 3 is formed to have the rectangular cross section slightly longer in the vehicle front-rear direction than in the vehicle width direction. However, the side sill upper surface 3c may be an inclined surface inclined toward the center of the side sill 3 in the vehicle width direction. In this case, the cross member upper surface 711 of the upper member 70 constituting the floor cross member 6 only needs be disposed in a range between the upper end position and the lower end position of the side sill outer 3a inclined in the vehicle up-down direction.

In the front floor panel 4, the floor convex portion 4c, on which the upper concave portion 72 of the upper member 70 and the lower concave portion 82 of the lower member 80 are superimposed, is formed to protrude upward in the vehicle. However, the floor convex portion 4c may protrude downward in the vehicle. In this case, the above-described lower member 80 is disposed above the front floor panel 4 in the vehicle and is fixed to the floor panel upper surface 4a, the upper member 70 is disposed below the front floor panel 4 in the vehicle and is fixed to the floor panel lower surface 4b. In this way, it is possible to suppress the protruding height of the floor cross member 6 in the vehicle up direction.

What is claimed is:

1. A vehicle lower body structure comprising:
a floor panel;
a pair of left and right side sills that extends in a vehicle front-rear direction at opposing lateral ends in a vehicle width direction of the floor panel; and
a floor cross member that extends in the vehicle width direction and couples the pair of left and right side sills, wherein the side sills each have a side sill upper surface facing upward in the vehicle and each have a closed cross section in a vertical cross section along the vehicle width direction,
the floor cross member includes: an upper member that is fixed to a floor panel upper surface of the floor panel, protrudes in a vehicle up direction, and has a cross member upper surface facing upward in the vehicle; and a lower member fixed to a floor panel lower surface of the floor panel and protruding downward in the vehicle, and
the side sill and the floor cross member are joined to align positions of the side sill upper surface and the cross member upper surface in the vehicle up-down direction, and the upper member, the lower member, and the floor panel between the upper member and the lower member form a closed cross section in a vertical cross section along the vehicle front-rear direction.

2. The vehicle lower body structure according to claim 1, wherein
the upper member includes three or more upper member ridgeline portions located at intervals in the vehicle front-rear direction, each of the upper member ridgeline portions extending the vehicle width direction.

3. The vehicle lower body structure according to claim 2, wherein
the lower member includes three or more lower member ridgeline portions located at intervals in the vehicle front-rear direction, each of the lower member ridgeline portions extending in the vehicle width direction.

4. The vehicle lower body structure according to claim 3, wherein
the floor cross member has joint portions provided at opposing ends in the vehicle width direction and joined to the side sill and a body portion between the joint portions on both sides in the vehicle width direction,
the upper member constituting the body portion has: upper convex portions protruding upward in the vehicle, disposed at intervals in the vehicle front-rear direction, and each having the cross member upper surface; and an upper concave portion coupling the upper convex portions in the vehicle front-rear direction and disposed lower in the vehicle than the cross member upper surface,
in a vertical cross section along the vehicle front-rear direction, the upper convex portions are disposed at intervals,
the lower member constituting the body portion has: lower convex portions protruding downward in the vehicle and disposed at intervals in the vehicle front-rear direction; and a lower concave portion coupling the lower convex portions in the vehicle front-rear direction, disposed higher in the vehicle than lower ends of the lower convex portions, and having a concave shape,
in the vertical cross section along the vehicle front-rear direction, the lower convex portions are disposed at intervals, and
the upper member and the lower member are joined by the upper concave portion and the lower concave portion.

5. The vehicle lower body structure according to claim 4, wherein
the floor panel is provided with a floor convex portion extending along the vehicle width direction and protruding to either side of the vehicle up-down direction,
the upper concave portion, the floor convex portion, and the lower concave portion are aligned in the vehicle up-down direction, and
the upper member and the lower member are joined by the upper concave portion and the lower concave portion via the floor convex portion.

6. The vehicle lower body structure according to claim 1, wherein
the upper member and the lower member each have a flange portion extending along the vehicle width direction and protruding in the vehicle front-rear direction, and
the upper member and the lower member are joined to the floor panel by the flange portions.

7. The vehicle lower body structure according to claim 6, wherein
a plurality of beads extending in the vehicle front-rear direction is disposed at intervals in the vehicle width direction on the flange portion formed along the vehicle width direction.

8. The vehicle lower body structure according to claim 1, wherein
the floor cross member includes: a first floor cross member disposed proximal a center position in the vehicle front-rear direction on the floor panel; and a second floor cross member disposed on a vehicle rear side at a predetermined distance from the first floor cross member.
